(19) United States
(12) Patent Application Publication
(10) Pub. No.: US 2017/0355089 A1
(43) Pub. Date: Dec. 14, 2017

(54) HAIR TRIMMER AND METHOD OF USING SAME

(71) Applicant: Kiss Nail Products, Inc., Port Washington, NY (US)

(72) Inventors: Kyusang Han, Port Washington, NY (US); Sung Lyul Park, Port Washington, NY (US); Siyong Sung, Port Washington, NY (US); Jisun Lee, Port Washington, NY (US); Hyoungsub Kim, Suzhou (CN); YoungHyuck Lee, Port Washington, NY (US); Samuel Park, Port Washington, NY (US)

(21) Appl. No.: 15/177,083

(22) Filed: Jun. 8, 2016

(51) Int. Cl. B26B 19/38; B26B 19/06

(52) U.S. Cl. CPC B26B 19/3853; B26B 19/3873; B26B 19/06

(57) ABSTRACT

A hair trimmer includes a cutting head and a body configured for easy reach of the hard to reach places, such as behind ears. This is achieved by shaping a front portion of the body to have cutouts behind the cutting head, which allow the trimmer to navigate around parts such as an ear. The cutouts also improve air flow around the front of the trimmer's body, thereby improving performance and durability of internal trimmer components through better cooling. The walls of the cutouts may have air ducts to further improve the cooling of the internal components. The cutouts also reduce the vibration of the cutting head and the body, leading to better trimming experience for the user and to improved durability of the trimmer. The method of using a trimmer with a cutting head and a body configured for easy reach of hard to reach places, such as behind ears, is also described.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

### 1. Field of the Invention

The following description relates to a hair trimmer including a body and a cutting head. Also, a method of using a hair trimmer is described. For example, a hair trimmer used for removing unwanted hair from difficult to reach regions is described.

### 2. Related Art

Hair trimmers are typically used by consumers for a number of different applications such as trimming moustaches, nose hair, hair on the temples, hair behind the ears, and other hair. One example of a hair trimmer is a facial hair trimmer. In using a hair trimmer, the user typically purchases the trimmer that includes a removable cutting head, and then uses the trimmer on a daily, weekly, or other regular interval. Cutting heads may be sold separately and may need to be replaced once the original cutting head becomes dull.

After each use of the hair trimmer, some maintenance steps may be performed, which include cleaning the cutting head with a brush or under a stream of running water. A trimmer brush is sometimes provided for cleaning the cutting head of the trimmer. The motor in the body of the trimmer may need to cool off between consecutive applications of the trimmer. The trimmer may be corded or cordless. A cordless trimmer typically has batteries, which may need to be replaced or recharged when they drain out. A corded trimmer may need to be plugged into an electric outlet to be charged.

Typically, the body of a hair trimmer is separate from the trimmer head and used to control the trimmer head for trimming a users hair. The body of a trimmer is typically a long extension in a longitudinal direction that is grasped by the user. Because a trimmer body is relatively large and long as compared to a trimmer head, the trimmer body may prevent the trimmer head from trimming unwanted hair in difficult to reach regions.

### SUMMARY OF THE INVENTION

In an aspect, a device for trimming hair includes a body including a front portion, a first cutout, and a second cutout, the first cutout and the second cutout positioned at the front portion of the body, and a cutting head attached to the front portion of the body.

In another aspect, a device for trimming hair includes a body with a front portion and a back portion on two opposite ends of a length of the body, a top portion and a bottom portion on two opposite ends of a height of a body, and a left portion and a right portion on two opposite ends of a width of the body, and a cutting head attached to the front portion including a stationary blade and a moving blade, each of the blades including teeth extending substantially perpendicular to the top portion, where the body has a first depression extending inward from a position defined by the front portion, the top portion, and the left portion, and a second depression extending inward from a position defined by the front portion, the top portion, and the right portion.

In an additional aspect, a hair trimmer includes a body including a front end, and a cutting head attached to the front end of the body and including teeth along one edge of the cutting head, where the front end is configured to allow the cutting head of the trimmer to reach regions behind a user's ear.

In yet another aspect, a method for trimming hair includes providing a hair trimmer including a body having a front portion and a back portion on two opposite ends of a length of the body, a top portion and a bottom portion on two opposite ends of a height of the body, and a left portion and a right portion on two opposite ends of a width of the body, and a cutting head attached to the front portion comprising a stationary blade and a moving blade, each of the blades comprising teeth extending substantially perpendicular to the top portion, where the body has a first depression extending inward from a position defined by the front portion, the top portion, and the left portion, and a second depression extending inward from a position defined by the front portion, the top portion, and the right portion, positioning the trimmer proximate to an area to be trimmed such that a portion of a user's body extends within the first depression or the second depression, and trimming the hair.

### DESCRIPTION OF THE SEVERAL VIEWS OF THE DRAWINGS

The foregoing summary, as well as the following detailed description, will be better understood when read in conjunction with the appended drawings. For the purpose of illustration, there are shown in the drawings certain embodiments of the present disclosure. It should be understood, however, that the invention is not limited to the precise arrangements and instrumentalities shown. The accompanying drawings, which are incorporated in and constitute a part of this specification, illustrate an implementation of systems and apparatuses consistent with the present invention and, together with the description, serve to explain advantages and principles consistent with the invention.

FIG. 1 is a diagram illustrating a top view of a prior art hair trimmer.

FIG. 2 is a diagram illustrating a top view of a prior art hair trimmer.

FIG. 3 is a diagram illustrating a top view of an example of a hair trimmer for trimming hair in difficult to reach regions.

FIG. 4 is a diagram illustrating a first perspective view of an example of the hair trimmer for trimming hair in difficult to reach regions.

FIG. 5 is a diagram illustrating an opposite perspective view of an example of the hair trimmer for trimming hair in difficult to reach regions.

FIG. 6 is a diagram illustrating the first perspective view of the example of the hair trimmer including a right cutout and air ducts.

FIGS. 7A and 7B are diagrams illustrating a top view of two examples of a hair trimmer with different examples of switches.

FIG. 8 is a diagram illustrating another example of a hair trimmer for trimming hair in difficult to reach regions.

### DETAILED DESCRIPTION OF THE INVENTION

Before explaining at least one example of the invention in detail, it is to be understood that the invention is not limited in its application to the details of construction and to the arrangements of the components set forth in the following description or illustrated in the drawings. The Figures and written description are provided to teach any person skilled in the art to make and use the inventions for which patent protection is sought. The invention is capable of other embodiments and of being practiced and carried out in various ways. Those skilled in the art will appreciate that not all features of a commercial embodiment are shown for the sake of clarity and understanding. Persons of skill in the art will also appreciate that the development of an actual commercial embodiment incorporating aspects of the present inventions will require numerous implementation—specific decisions to achieve the developer's ultimate goal for the commercial embodiment. While these efforts may be complex and time-consuming, these efforts nevertheless would be a routine undertaking for those of skill in the art having the benefit of this disclosure.

In addition, it is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity in specific reference to the Figures and are not intended to limit the scope of the invention or the appended claims. Further, it should be understood that any one of the features of the invention may be used separately or in combination with other features. Other systems, methods, features, and advantages of the invention will be or become apparent to one with skill in the art upon examination of the Figures and the detailed description. It is intended that all such additional systems, methods, features, and advantages be included within this description, be within the scope of the present invention, and be protected by the accompanying claims.

FIG. 1 is a diagram illustrating a top view of an example of a prior art hair trimmer. This trimmer shape, sometimes referred to as a “square blade trimmer,” represents an elongated body of the trimmer connected at one of its ends to a cutting head. In this prior art hair trimmer, the width of the cutting head is slightly larger than the width of the body at the front end, or the end that is connected to the cutting head. Also, the connection between the body and the cutting head is smooth, such that the front end of the body smoothly transitions to the side of the cutting head that is attached to the body. In this trimmer, substantially the whole width of the body at the front end is in contact with the cutting head, and substantially the whole width of the cutting head is in contact with the front end of the body.

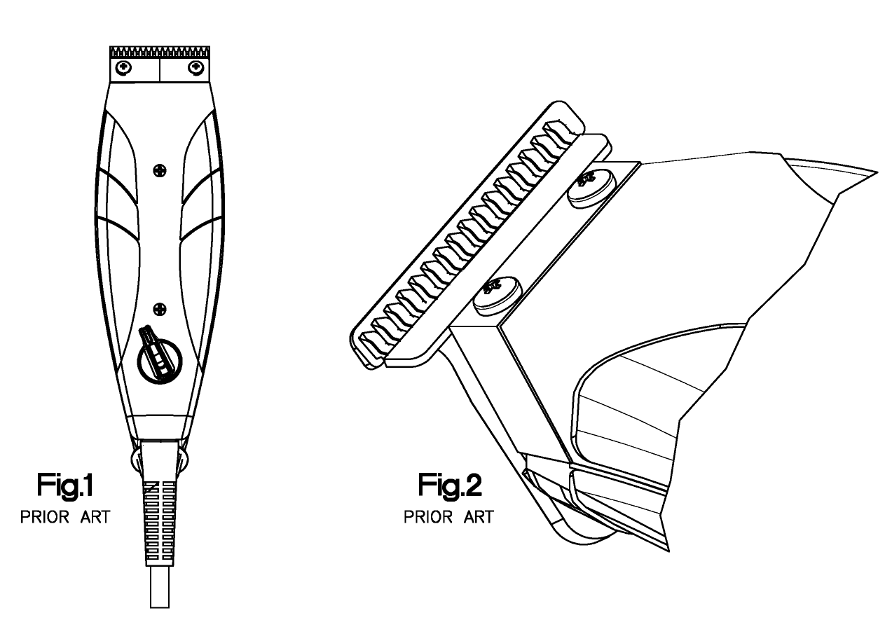

FIG. 2 is a diagram illustrating a top view of another example of a prior art hair trimmer. This trimmer shape, sometimes referred to as a “T-trimmer,” represents an elongated body of the trimmer connected at its front end to a cutting head. In this example, the width of the cutting head is slightly larger than the width of the side of the body that is connected to the cutting head. In this example, the connection between the body and the cutting head is abrupt, such that the body abuts the side of the cutting head that is attached to the body, but the transition between the body and the cutting head is not smooth because the cutting head is wider than the mating part of the body. In this example, substantially the whole width of the body at the front end is in contact with the cutting head, but not the whole width of the cutting head is in contact with the body because the outside portions of the cutting head protrude beyond the width of the body.

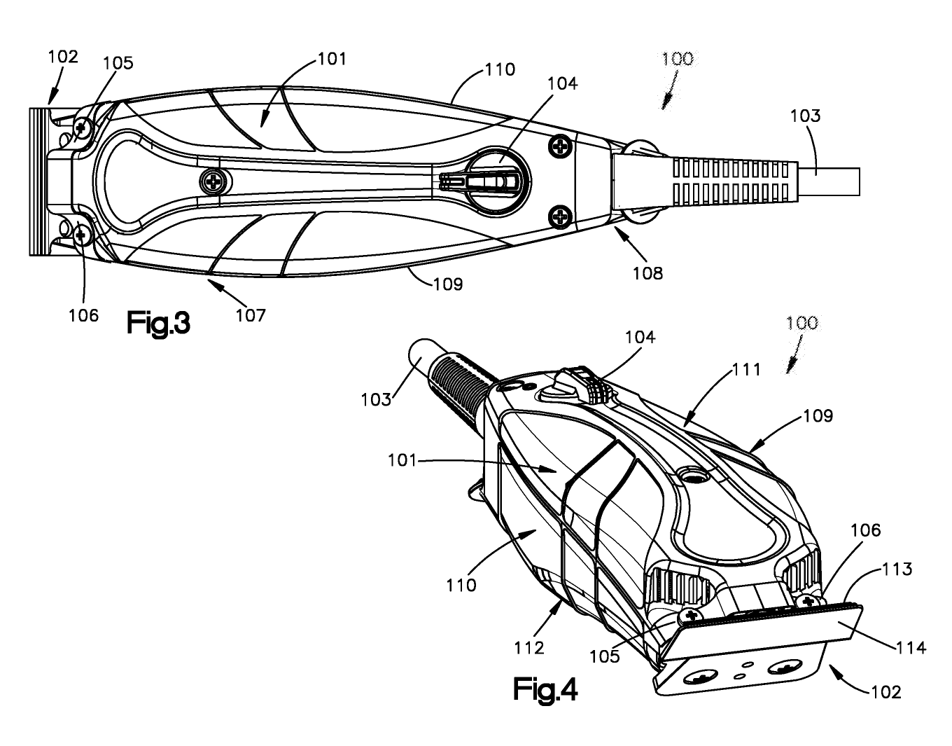

FIG. 3 is a diagram illustrating a top view of an example of a hair trimmer 100 for trimming hair in difficult to reach regions. In this example, trimmer 100 includes a body 101 and a cutting head 102. The trimmer 100 also includes a cord 103. The body 101 includes a front portion 107 and a back portion 108. The front portion 107 and the back portion 108 are located at opposite ends of the length of the body 101. The body 101 includes a left portion 109 and a right portion 110. The left portion 109 and the right portion 110 are located at opposite ends of the width of the body 101. The body 101 further includes a switch 104 for turning on the trimmer 100. In a preferred example, the cutting head 102 is attached to the body 101 at its front portion 107, and the cord 103 is attached to the body 101 at its back portion 108. In some examples, the front portion 107 of the body 101 comprises cutouts. The body 101 may include one or more cutouts at different regions of the body 101, and in the preferred example illustrated in FIG. 3, there are two cutouts 105 and 106. The left cutout 106 is on the left portion 109 of the body 101, and the right cutout 105 is on the right portion 110 of the body 101.

FIG. 4 is a diagram illustrating a perspective view of an example of the hair trimmer 100 with the right cutout 105 and the left cutout 106. The body 101 includes a top portion 111 and a bottom portion 112. The top portion 111 and the bottom portion 112 are located at the opposite ends of the height of the body 101. In an example, the switch 104 is located on the top portion 111 of the body 101. In this example, the cutting head 102 includes a moving blade 113 and a stationary blade 114. The moving blade 113 is located on the side of the cutting head 102 that faces the body 101. The stationary blade 114 is located on the side of the cutting head 102 that faces away from the body 101. The moving blade 113 may be capable of moving back and forth in its plane, along the line generally parallel to the width of the body 101.

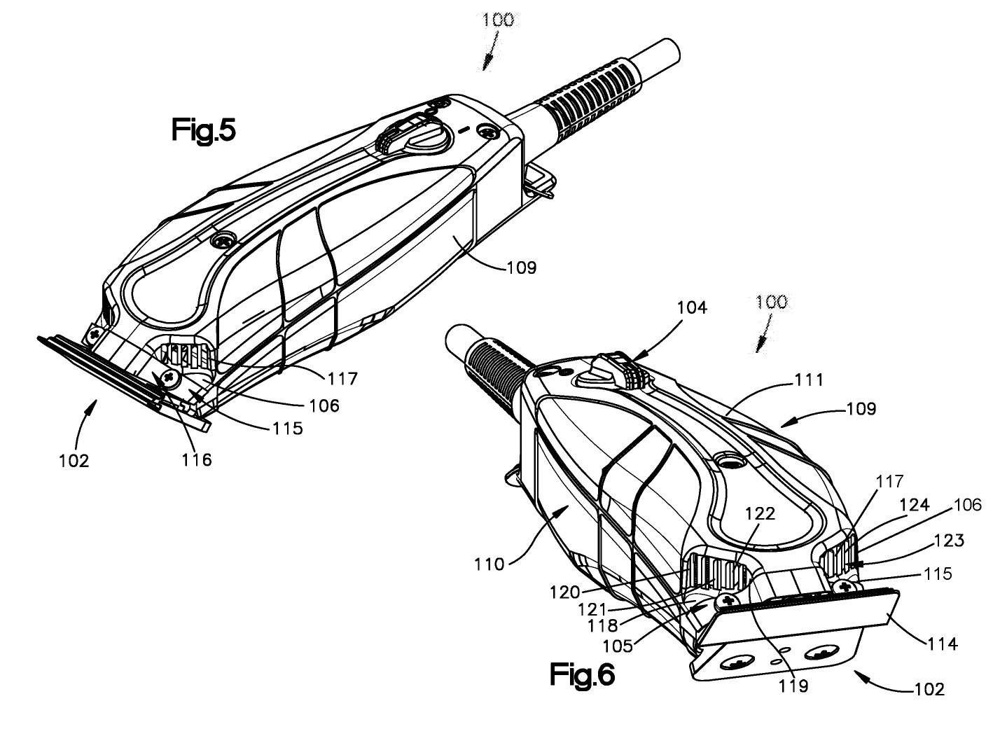

FIGS. 5 and 6 are diagrams illustrating perspective views of an example of the hair trimmer with elements of the cutouts 105 and 106. Referring to FIG. 5, some elements of the left cutout 106 are illustrated. In an example, the left cutout 106 comprises a bottom surface 115 of the left cutout. In this example, the left cutout 106 comprises a side surface 116 of the left cutout. In this example, the left cutout 106 comprises a back surface 117 of the left cutout. The bottom surface 115 is generally parallel to the top portion 111 and the bottom portion 112 of the body 101. The side surface 116 is generally parallel to the left portion 109 and the right portion 110 of the body 101. The side surface 116 is generally perpendicular to the bottom surface 115. The back surface 117 is generally perpendicular to the bottom surface 115. The back surface 117 extends from the side surface 116 of the left cutout 106 to the left portion 109 of the body 101. An angle between the side surface 116 and the back surface 117 is obtuse such that the farther it is from the side surface 116, the larger is a distance between the back surface 117 and the cutting head 102.

Referring to FIG. 6, some elements of the right cutout 105 are illustrated. In an example, the right cutout 105 includes a bottom surface 118 of the right cutout. In this example, the right cutout 105 includes a side surface 119 of the right cutout. The right cutout 105 includes a back surface 120 of the right cutout. The bottom surface 118 is generally parallel to the top portion 111 and the bottom portion 112 of the body 101. The side surface 119 is generally parallel to the left portion 109 and the right portion 110 of the body 101. The side surface 119 is generally perpendicular to the bottom surface 118. The back surface 120 is generally perpendicular to the bottom surface 118. The back surface 120 extends from the side surface 119 of the right cutout 105 to the right portion 110 of the body 101. An angle between the side surface 119 and the back surface 120 is obtuse such that the farther it is from the side surface 119, the larger is a distance between the back surface 120 and the cutting head 102.

Still referring to the example illustrated in FIG. 6, the back surface 120 of the right cutout 105 includes air ducts 121. In this example, the air ducts 121 include slots 122 that are generally perpendicular to the bottom surface 118. Similarly, back surface 117 of the left cutout 106 includes air ducts 123. The air ducts 123 include slots 124 that are generally perpendicular to the bottom surface 115.

In an example, the body 101 is substantially cylindrical, such that the front portion 107 and the back portion 108 are the ends of the cylindrical shape of the body, and the left portion 109, the right portion 110, the top portion 111, and the bottom portion 112 are various portions of the curved surface of a cylindrical shape of the body. In this example, the right cutout 105 extends inward from a position at the intersection of the front, right, and top portions of the body, and the left cutout 106 extends inward from a position at the intersection of the front, left, and top portions of the body.

In some examples, cross-sections of the body 101 perpendicular to a longitudinal axis of the body are substantially rectangular, or substantially circular, or substantially oval, such that the cross-sectional shape and size may vary along the length of the body.

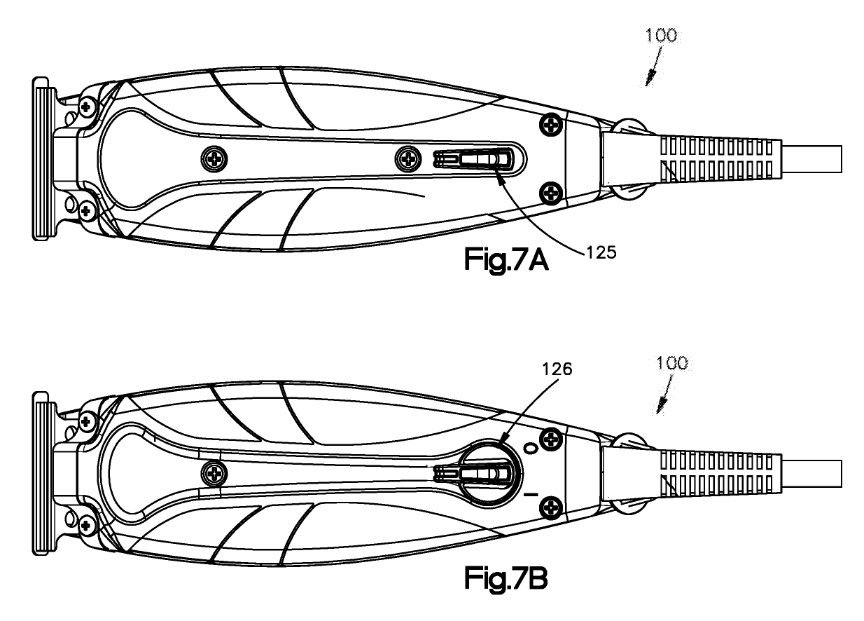

FIG. 7 is a diagram illustrating a top view of two examples of a hair trimmer with examples of switches. In an example, the switch 104 is a sliding switch 125 as illustrated in FIG. 7(a). In another example, the switch 104 is a turning switch 126 as illustrated in FIG. 7(b).

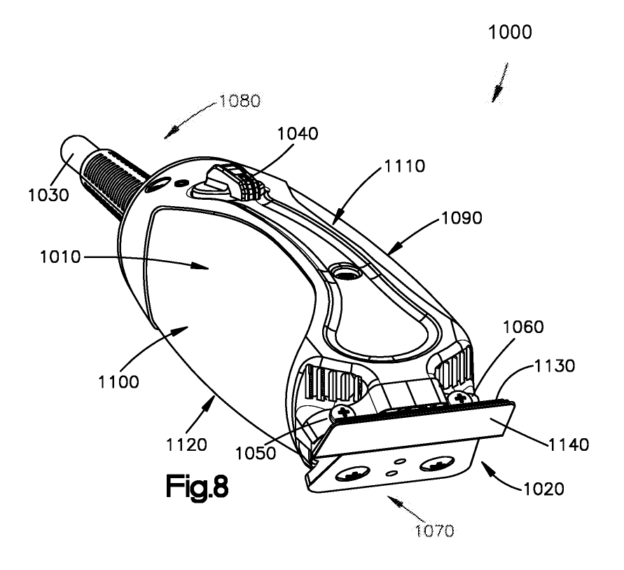

FIG. 8 is a diagram illustrating another example of a hair trimmer 1000 for trimming hair in difficult to reach regions. Referring to FIG. 8, a hair trimmer 1000 for trimming hair in difficult to reach regions may have a cylindrical or other shape. For example, the trimmer 1000 includes a body 1010 having the shape of an elongated cylinder and a cutting head 1020. The trimmer 1000 also includes a cord 1030. The body 1010 includes a front portion 1070 and a back portion 1080. The front portion 1070 and the back portion 1080 are located at opposite ends of the length of the body 1010. The body 1010 includes a left portion 1090 and a right portion 1100. The left portion 1090 and the right portion 1100 are located at opposite ends of the width of the body 1010. The body 1010 may further includes a switch for turning on the trimmer 1000. In a preferred example, the cutting head 1020 is attached to the body 1010 at its front portion 1070, and the cord 1030 is attached to the body 1010 at its back portion 1080. In some examples, the front portion 1070 of the body 1010 includes cutouts 1050, 1060. The body 1010 may include one or more cutouts at different regions of the body 1010, and in the preferred example illustrated in FIG. 3, there are two cutouts 1050 and 1060. The left cutout 1060 is on the left side 1090 of the body 1010, and the right cutout 1050 is on the right side 1100 of the body 1010. The cutting head 1020 may be secured to the body 1010 using a fastening element that is secured by one or more screws. The fastening element extends across the top surface of the trimmer 1000 from the right cutout 1050 to a middle protruding portion to the left cutout 1060, and the screws may be positioned within the right cutout 1050 and the left cutout 1060.

While the examples of the trimmer 100, 1000 described include a cuboidal shape and a cylindrical shape, the invention is not limited to such shapes. Other well known shapes for a hair trimmer 100, 1000 are also included and described to a person having ordinary skill in the art, and may be modified to include such cutouts 105, 1050, 106, 1060 at a front portion of the body 101 as described herein. In the above examples, the cutouts 105, 1050, 106, 1060 allow for cutting hair in hard to reach places, such as behind ears. The cutouts 105, 1050, 106, 1060 create a gap between the cutting head of the trimmer and the trimmer's body, such that an ear or another part may be partially positioned in these gaps while the cutting head reaches the hair that is being trimmed. Without the cutouts, trimming hair in such places would be difficult, or would only be accomplished with an inconvenience or pain of the user.

In an example, the cutouts 105, 1050, 106, 1060 create air pockets between the cutting head of the trimmer and the trimmer's body, such that the internal components of the trimmer are better cooled. Typically, the internal components of the trimmer such as a motor, an electromagnetic coil, or other internal components, become hot during normal operating duty cycle of the trimmer, and may overheat in case of a long continuous operation. This leads to degradation of trimmer's performance or premature failure. In an example, the air pockets created by the cutouts 105, 1050, 106, 1060 lead to lower operating temperatures of the internal components of the trimmer, or improvements in their performance, or extension of their useful life.

In an example, the cutouts 105, 1050, 106, 1060 allow for a reduced vibration of the cutting head of the trimmer and of the trimmer's body. Reduced vibration of the cutting head allows for more precise and more comfortable trimming action. Reduced vibration of the trimmer's body allows for more comfortable handling of the trimmer.

In an example, the trimmer is operated without a cord. In another example, the trimmer operates with a cord. In this example, the trimmer may operate with a swivel cord that is configured to swivel around its own axis while maintaining electrical contact with the trimmer's body. Such swivel action of the cord allows for the user to use the trimmer at various portions of their face without creating kinks in the cord. This leads to increased operating life of a trimmer equipped with a cord.

In an example, a method of using a hair trimmer is provided. In this example, a method of using a hair trimmer includes providing a trimmer, turning on the trimmer, positioning the trimmer in such a way that the cutting head is located in close proximity to the unwanted hair, and trimming the unwanted hair. In another example, a method of using a hair trimmer includes positioning the trimmer in such a way that the cutting head is located in close proximity to the unwanted hair, turning on the trimmer, and trimming the unwanted hair. In an example, a method of using a hair trimmer includes providing a trimmer that has a cutting head attached to a body where the body is configured with cutouts on the side of the body located next to the cutting head.

In an example, a method of trimming hair is provided. In this example, a method of trimming hair includes turning on the trimmer, positioning the trimmer in such a way that the cutting head is located in close proximity to the unwanted hair, and trimming the unwanted hair. In another example, a method of trimming hair includes positioning the trimmer in such a way that the cutting head is located in close proximity to the unwanted hair, turning on the trimmer, and trimming the unwanted hair. In an example, a method of trimming hair includes providing a trimmer that has a cutting head attached to a body where the body is configured with cutouts on the side of the body located next to the cutting head.

A hair trimmer provided herein has significant advantages over the prior art hair trimmers. It may provide better access to some unwanted hair, it may provide access to previously inaccessible unwanted hair, it may reduce a discomfort of trimming hair, it may eliminate a discomfort of trimming hair, it may lower operating temperatures of the trimmer, it may lower operating temperatures of internal components of the trimmer, it may lower surface temperatures of the trimmer's body, it may lower operating temperatures of the cutting head, it may allow for lower weight of the trimmer, it may allow for use of stronger, or less expensive, or lighter weight, materials in the construction of the trimmer, it may reduce the vibration of the trimmer, it may allow for use of more durable, or less expensive, or lighter weight, internal and external components of the trimmer, it may reduce the vibration of the trimmer body, it may reduce vibration of the cutting head, it may reduce the vibration of internal components of the trimmer, it may reduce operating noise of the trimmer, it may increase durability of the trimmer, it may increase durability of the cutting head, it may increase durability of internal components of the trimmer, it may increase time between changes of the cutting head, it may increase time between changes of trimmer battery, it may extend time the trimmer can operate on a single charge, it may decrease need for maintenance of the trimmer. While several advantages are described, it should be appreciated by one of ordinary skill in the art that the advantages of the hair trimmer are not limited to those described herein.

A trimmer body may be made of various materials including metal, plastic, resin, wood, or a combination thereof. A cutting head may be made of various materials including metal, plastic, resin, wood, or a combination thereof. A cord may be made of various materials including plastic, resin, or a combination thereof. The materials are not limited to those described herein.

A trimmer may be battery operated or electric outlet power operated, or both. A battery operated trimmer may have one or more batteries that need to be exchanged to new batteries when the previous set of batteries runs out of energy. A battery operated trimmer may have rechargeable batteries that may be recharged and reused. A battery operated trimmer may have continuously rechargeable batteries that recharge by induction charging or another continuously charging method. A trimmer that operates on electric outlet power may have a cord for connecting the trimmer to an electric power outlet.

It will be appreciated by those skilled in the art that changes could be made to the embodiments described above without departing from the broad inventive concept thereof. It is understood, therefore, that the invention disclosed herein is not limited to the particular embodiments disclosed, but it is intended to cover modifications within the spirit and scope of the present invention as defined by the appended claims.

What is claimed is:

1. A device for trimming hair, comprising:
a body comprising a front portion, a first cutout, and a second cutout, the first cutout and the second cutout positioned at the front portion of the body; and
a cutting head attached to the front portion of the body.

2. The device of claim 1, wherein the body further comprises:
a top portion and a bottom portion on two opposite ends of a height of the body;
a left portion and a right portion on two opposite ends of a width of the body; and
a back portion, such that the front portion and the back portion are on two opposite ends of a length of the body,
wherein the first cutout extends inward from a position defined by the front portion, the top portion, and the left portion, and the second cutout extends inward from a position defined by the front portion, the top portion, and the right portion.

3. The device of claim 2, wherein each of said cutouts further comprises:
a bottom surface substantially parallel to the top portion and the bottom portion of the body;
a side surface substantially parallel to the left portion and the right portion of the body; and
a back surface substantially perpendicular to the bottom surface and forming an obtuse angle with the side surface such that an extension of the bottom surface from the back surface to the front portion increases as the bottom surface extends from the side surface to the left portion or the right portion.

4. The device of claim 3, further comprising a plurality of air ducts positioned on at least one of the back surfaces.

5. The device of claim 4, wherein the plurality of air ducts are oriented substantially perpendicular to the bottom surface.

6. The device of claim 3, wherein the cutting head comprises a stationary blade and a moving blade.

7. The device of claim 6, wherein each of the blades comprises teeth extending substantially perpendicular to the top portion of the body.

8. The device of claim 2, further comprising an electric cord attached to the back portion of the body.

9. The device of claim 8, wherein the electric cord further comprises a nut assembly that attaches the electric cord to the back portion of the body and is configured to allow the electric cord to swivel around its longitudinal axis.

10. A device for trimming hair, comprising:
a body with a front portion and a back portion on two opposite ends of a length of the body, a top portion and a bottom portion on two opposite ends of a height of a body, and a left portion and a right portion on two opposite ends of a width of the body; and
a cutting head attached to the front portion comprising a stationary blade and a moving blade, each of the blades comprising teeth extending substantially perpendicular to the top portion,
wherein the body has a first depression extending inward from a position defined by the front portion, the top portion, and the left portion, and a second depression extending inward from a position defined by the front portion, the top portion, and the right portion.

11. The device of claim 10, wherein each of said depressions further comprises:
a bottom surface substantially parallel to the top portion and the bottom portion of the body;
a side surface substantially parallel to the left portion and the right portion of the body; and
a back surface substantially perpendicular to the bottom surface and forming an obtuse angle with the side surface such that an extension of the bottom surface from the back surface to the front portion increases as the bottom surface extends from the side surface to the left portion or the right portion.

12. The device of claim 11, further comprising a plurality of air ducts positioned on each of the back surfaces.

13. The device of claim 12, wherein the plurality of air ducts are oriented substantially perpendicular to the bottom surface.

14. The device of claim 10, further comprising an electric cord attached to the back portion of the body.

15. The device of claim 14, wherein the electric cord further comprises a nut assembly that attaches the electric cord to the back portion of the body and is configured to allow the electric cord to swivel around its longitudinal axis.

16. The device of claim 10, wherein at least one of the blades extends beyond the right portion and the left portion of the body at the front portion of the body to form a t-shape with the body.

17. A hair trimmer, comprising:
a body comprising a front portion; and
a cutting head attached to the front portion of the body and comprising teeth along one edge of the cutting head;
wherein the front portion is configured to allow the cutting head of the trimmer to reach regions behind a user's ear.

18. The trimmer of claim 17, wherein the front portion comprises two cutouts at two adjacent positions of the front portion of the body.

19. The trimmer of claim 18, further comprising a plurality of air ducts in the cutouts.

20. The trimmer of claim 19, wherein the plurality of air ducts comprise slots to enable ventilation of the body.

21. The trimmer of claim 17, further comprising an electric cord attached to a back portion of the body.

22. The trimmer of claim 21, wherein the attachment of the electric cord to the back portion of the body allows the electric cord to swivel around its axis.

23. A method for trimming hair, comprising the steps of:
providing a hair trimmer comprising:
a body having a front portion and a back portion on two opposite ends of a length of the body, a top portion and a bottom portion on two opposite ends of a height of the body, and a left portion and a right portion on two opposite ends of a width of the body; and
a cutting head attached to the front portion comprising a stationary blade and a moving blade, each of the blades comprising teeth extending substantially perpendicular to the top portion,
wherein the body has a first depression extending inward from a position defined by the front portion, the top portion, and the left portion, and a second depression extending inward from a position defined by the front portion, the top portion, and the right portion;
positioning the trimmer proximate to an area to be trimmed such that a portion of a user's body extends within the first depression or the second depression; and
trimming the hair.

24. The device of claim 1, wherein the body has a cuboid-like or cylindrical-like shape.

25. The device of claim 1, wherein each of the first cutout and the second cutout comprises at least one surface, and wherein a plurality of air ducts are positioned on the at least one surface of the first or the second cutout.

26. The device of claim 25, wherein the cutting head comprises a stationary blade and a moving blade.

27. The device of claim 26, wherein each of the blades comprises teeth extending substantially parallel to the front portion of the body.

28. The device of claim 27, wherein the plurality of air ducts are oriented substantially parallel to the teeth of the blades.
